(19) United States
(12) Patent Application Publication
(10) Pub. No.: US 2026/0116037 A1
(43) Pub. Date: Apr. 30, 2026

(54) TANK LINING

(71) Applicant: ADLER & ALLAN LIMITED, Harrogate Yorkshire (GB)

(72) Inventors: Francis HOLLIER, Carterton Oxfordshire (GB); Mark LAWSON, Carterton Oxfordshire (GB)

(21) Appl. No.: 19/166,938

(22) PCT Filed: Mar. 12, 2024
(86) PCT No.: PCT/GB2024/050661

§ 371 Date: Sep. 19, 2025

(30) Foreign Application Priority Data
Mar. 22, 2023 (GB) 2304154.4

(51) Int. Cl. B32B 3/30; B32B 7/12; B32B 15/02; B32B 15/08; B32B 15/14; B32B 15/20; B32B 37/24; B65D 90/04; B65D 90/501

(52) U.S. Cl. CPC B32B 3/30; B32B 7/12; B32B 15/02; B32B 15/08; B32B 15/14; B32B 15/20; B32B 37/24; B65D 90/04; B65D 90/501; B32B 2037/243; B32B 2250/03; B32B 2262/101; B32B 2262/103; B32B 2305/38; B32B 2307/4026; B32B 2307/7242; B32B 2307/7265; B32B 2439/40

(57) ABSTRACT

The present application describes a fluid impervious composite lining (100) for a storage vessel, comprising a base layer (102) adherable to an inner surface of a storage vessel wall, at least one fluid impervious layer (108), and a woven mesh layer (106) located between the base layer and the at least one fluid impervious layer, wherein the woven mesh layer defines a plurality of open cells in fluid communication with each other to form a monitorable interstitial space within the lining. A method of lining a storage vessel with the composite lining is also described.

The present invention relates to tanks and storage vessels and more specifically to a lining thereof to provide a monitorable interstitial space between the vessel wall and a layer of the lining.

Storage vessels have been manufactured from a variety of materials are used to store liquids in above and below ground applications. Other than monitoring the contents of the vessel by for example the height of the stored liquid in the vessel, the weight of the stored liquid, and/or the time for a sound or light source to travel through the stored liquid, single wall vessels cannot be directly and continuously monitored for loss of integrity. Loss detection by the monitoring methods described above rely on migration of the contents fully or partially from the vessel which in turn presents a risk to life and the environment. It is therefore known to incorporate a pressure sensor in an interstitial space provided between the vessel wall and a layer of a lining applied to the vessel wall such that a leak can be detected without the contents leaking fully or partially from the vessel, i.e. the liquid is contained and can be removed from the vessel without complete loss.

EP2073974A describes a tank lining including a non-woven high-density polyethylene (PU) grid encapsulated within a composite material to form an interstitial space therein. The grid is formed by two arrays of elongate elements arranged at an angle to each other with the elements of each array lying in a different plane and thereby allowing for the free passage of fluid, e.g. air, through the grid. The integrity of the interstitial space is monitored by for example a vacuum monitoring system. However, the non-woven grid is relatively thick to provide the interstitial space which undesirably impinges on the usable volume of the tank. Furthermore, the non-woven grid creates ‘dead-spots’ at the regions where the elongate elements of the two arrays cross, i.e. the vessel could become punctured or fail at one or more of these regions without penetrating the interstitial space such that the leak would be undetected. In addition, the PU grid tends to spring back during installation which can be time consuming and frustrating for the installers.

It is an aim of certain embodiments of the present invention to provide a tank lining assembly that is compact to maximise the storage volume of the tank and which is non-complex and efficient to install.

It is an aim of certain embodiments of the present invention to provide a tank lining assembly including a monitorable interstitial space configured to minimise/eliminate dead-spots as associated with some known lining systems and methods.

According to a first aspect of the present invention there is provided a fluid impervious composite lining for a storage vessel, comprising:
a base layer adherable to an inner surface of a storage vessel wall;
at least one fluid impervious layer; and
a woven mesh layer located between the base layer and the at least one fluid impervious layer, wherein the woven mesh layer defines a plurality of open cells in fluid communication with each other to form a monitorable interstitial space within the lining.

Optionally, the woven mesh layer is located on an inner surface of the base layer.

Optionally, the woven mesh layer comprises a metallic material.

Optionally, the metallic material is aluminium.

Optionally, the liner comprises a spacer layer having spaced apart protrusions extending towards the base layer and defining a plurality of passageways between the protrusions, wherein the protrusions of the spacer layer engage the woven mesh layer and the plurality of passageways and open cells are fluidly connected to laterally extend a monitorable volume of the interstitial space.

Optionally, the spacer layer comprises a sheet panel region defining an outer surface from which the protrusions extend and an opposed substantially smooth inner surface.

Optionally, the spacer layer is preformed.

Optionally, the spacer layer comprises a glass reinforced plastic material.

Optionally, the base layer comprises a substantially flexible material.

Optionally, the at least one fluid impervious layer comprises a first sealing layer applied to the inner surface of the spacer layer, wherein the first sealing layer comprises a first colour pigment.

Optionally, the at least one fluid impervious layer comprises a second sealing layer applied to the first sealing layer, wherein the second sealing layer comprises a second colour pigment different to the first colour.

Optionally, the at least one fluid impervious layer comprises a third sealing layer applied to the second sealing layer, wherein the third sealing layer comprises a third colour pigment different to the second colour.

Optionally, the second and third sealing layers comprise a chemical resistant plastic resin.

Optionally, adjacent layers of the liner are adhered to each other by adhesive tape.

Optionally, the tape is configured to dissolve in petroleum fuel.

According to a second aspect of the present invention there is provided a storage vessel comprising a lining according to the first aspect of the present invention.

According to a third aspect of the present invention there is provided a method of lining a storage vessel with a fluid impervious composite lining, comprising:
applying a base layer to an inner surface of a storage vessel wall;
locating a woven mesh layer inboard of the base layer, wherein the mesh layer defines a plurality of open cells in fluid communication with each other to form a monitorable interstitial space within the lining; and
applying at least one fluid impervious layer inboard of the mesh layer.

Optionally, the method comprises locating a spacer layer on the mesh layer, wherein the spacer layer comprises spaced apart protrusions extending towards and engaged with the mesh layer and defines a plurality of passageways between the protrusions fluidly connected with the open cells of the mesh layer to laterally extend a monitorable volume of the interstitial space.

Optionally, the spacer layer is preformed.

Optionally, applying at least one fluid impervious layer comprises applying a first sealing layer to a substantially smooth inner surface of the spacer layer, wherein the first sealing layer comprises a first colour pigment.

Optionally, applying at least one fluid impervious layer comprises applying a second sealing layer to the first sealing layer, wherein the second sealing layer comprises a second colour pigment different to the first colour.

Optionally, applying at least one fluid impervious layer comprises applying a third sealing layer to the second sealing layer, wherein the third sealing layer comprises a third colour pigment different to the second colour.

Optionally, the method comprises locating double-sided adhesive tape between adjacent ones of said layers.

Optionally, the tape is dissolvable in petroleum fuel.

Optionally, the woven mesh layer comprises a metallic material, and optionally aluminium.

### DESCRIPTION OF THE DRAWINGS

Certain embodiments of the present invention will now be described with reference to the accompanying drawings in which:

FIG. 1 illustrates a schematic exploded section of a tank liner assembly according to certain embodiments of the present invention; and FIGS. 2a and 2b illustrate a schematic cross section through the base layer, mesh layer and composite layer of the liner assembly according to different embodiments of the present invention.

### DETAILED DESCRIPTION

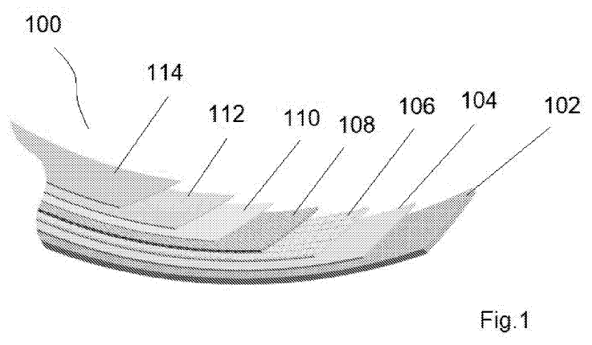

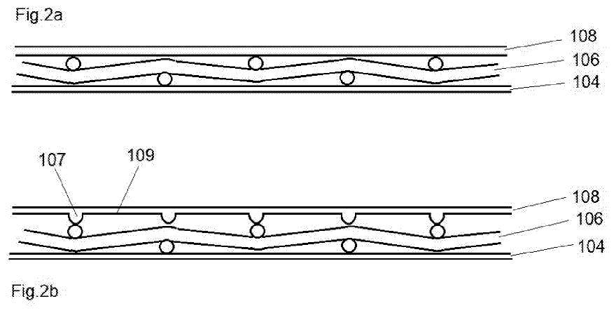

As illustrated in FIG. 1, a tank liner assembly 100 according to certain embodiments of the present invention includes a base layer of composite plastic material 104 adhered to the inside surface of a tank wall 102. The base layer aptly comprises chopped-strand glass fibre matt and polyester resin. The base layer aptly provides a substantially uniform inner surface whilst providing optimal adhesion to the tank wall surface which is aptly media-blasted to remove any corrosion etc. and/or is a profiled surface. The base layer has strength and integrity and acts as a sound base layer for supporting the other layers of the liner assembly. Saturating the layer of chopped strand mat with resin ensures a sufficient amount of resin is applied when compared with a sprayed coat of resin which can only be randomly spot tested for thickness. Aptly, a thickness of the base layer 102 is around 1.5 mm. The terms ‘inner’ and ‘outer’ will be used in relation to the inside the tank as opposed to outside the tank, i.e. a layer distal from the tank wall will be innermost compared to a layer proximal to the tank wall which will be outermost.

A woven mesh layer 106 is then located on the inner surface of the base layer 104. As illustrated in FIGS. 2a and 2b, the mesh layer 106 comprises wire elements oriented substantially perpendicularly with respect to each other in an over and under arrangement of warps and wefts to define a woven mesh of open cells. The peaks and troughs of the single woven mesh layer ensure there is always a gap between an adjacent layer of the liner and the mesh at any one point which in turn eliminates any closed cells or ‘dead spots’ in the liner which could otherwise risk a lateral penetration or leak going undetected. Aptly, the mesh count is around 40 (i.e. 40 wires crossing per square inch (approximately 6.45 cm²), the hole size is around 0.41 mm and the wire diameter is around 0.22 mm. Aptly, a thickness of the mesh layer 106 is around 0.8 mm. The relatively fine wire elements also mean a 2 mm hole which is the typical standard for leak testing would also pass fully through a wire element and into a gap thereby releasing the vacuum in the interstitial space which can then be efficiently detected. The mesh layer is aptly aluminium but may be a different metal material, such as stainless steel or mild steel, or alternatively a plastics/polymer material such as PU. However, aluminium is substantially ductile and can desirably be taken off a roll and conform efficiently to the curvature of the tank wall during installation without substantial spring-back. A woven mesh has been found by the applicant to be substantially flexible across all planes, allowing it to be efficiently applied to the dished ends of cylindrical storage tanks with minimal layup adhesive and without creasing, and also to relatively large area sections with minimum cutting and joining. A woven mesh layer can also be overlapped at corners and edges thereof when applied to the tank wall ensuring full communication through a 90° change of plane. The amount of layup adhesive tape required is also minimised in view of the ‘off-roll’ memory of the mesh layer is minimal. Aluminium is also electrically conductive and can be used as an earthing element to dissipate static which can otherwise cause a significant risk of sparking and igniting a flammable liquid or gas. A metal mesh can also be used to determine the thickness, integrity and consistency of the top layers applied over the mesh layer to confirm the liner assembly has been installed correctly by using an ultrasonic thickness gauge or the like. A woven mesh layer allows for a substantially thinner overall liner assembly which desirably means the liner assembly has minimal impact on the capacity of the lined vessel. In contrast, a non-woven mesh used to form an interstitial space in a composite liner typically has to be multi-layered, i.e. two or more substantially flat and punched-out mesh sheet layers, and the mesh layers have to be offset to misalign the mesh cells in an attempt to avoid dead spots in lateral communication. However, this makes the assembly process particularly time consuming and difficult to ensure the required misalignment between the mesh layers is achieved over the entire vessel area which can give rise to issues caused by mis-application by the installers. i.e. the mesh layers not being correctly offset with respect to each other and closed cells being unintentionally formed. The woven mesh layer according to certain embodiments of the present invention does not require any such alignment to avoid closed cells being formed and in turn the risk of lateral ‘dead spots’.

Furthermore, a woven mesh allows for excellent communication even at finer profiles, and also allows for both linear and non-linear communication across a large single surface area, avoiding ‘dead spots’ and allowing sensing systems do detect change promptly.

As illustrated in FIG. 2b, a preformed composite layer 108 is located on the inner side of the mesh layer 106 and comprises a plurality of spaced apart protrusions 107 extending from an outer surface 109 thereof towards the mesh layer 106. The protrusions may be consistently or randomly spaced apart from each other. Aptly, the protrusions are relatively small reoccurring dome-shaped protrusions having a height of around 4 mm or less. Alternatively, the protrusions could be diamond/pyramid-shaped, cylindrical rods, dog-tooth, castellated, or the like. Aptly, the composite layer 108 covers the entire mesh layer and provides an inner surface for the following top coat layers to be applied and adhered to. The protrusions of this layer 108 define linked passageways therebetween and also space the outer surface of this layer, from which the protrusions extend, from the inner side of the mesh layer 106 such that the passageways fluidly communicate with the interstitial space defined by the mesh layer 106 to thereby widen the interstitial space and increase the volume thereof and in turn air flow through the interstitial space. The protrusions also allow the sheet-like support portion of this layer, which defines the inner and outer surfaces thereof, to be relatively thin and flexible whilst still providing strength to the layer itself. This layer is substantially flexible to allow a sizeable section to be manoeuvred through the tank manway whilst also conforming to the curvature of the tank for ease of installation. This layer aptly comprises a glass fibre and polyester resin composite which is preformed to avoid having to lay-up this layer in an uncured fluid state on the mesh layer which would undesirably block the mesh cells with resin during installation. Aptly, a thickness of the composite spacer layer 108 is around 2.3 mm. Alternatively, as illustrated in FIG. 2a, the preformed layer 108 may be substantially flat on both surfaces and not include any projections or protrusions extending from the outer surface 109 thereof to space the same from the mesh layer 106.

A polyester-based flow-coat layer 110 is applied to the inner surface of the composite layer 108 to provide a substantially smooth inner surface. This layer is aptly pigmented white to provide a clear visual indicator to the installer that the entire outer surface of the composite layer 108 has been covered, but it may be any suitable colour for this purpose. Aptly, a thickness of the flow-coat layer 110 is around 0.3 mm.

A first top coat layer of plastic/vinyl ester resin 112 with a relatively high chemical resistance is applied to the inner surface of the flow-coat layer 110. The first top coat layer 112 is aptly pigmented grey to provide a clear visual indicator to the installer that the entire outer surface of the flow-coat layer 110 has been covered, but it may be any suitable colour for this purpose. This layer is substantially fuel resistant, particularly to ethanol. Aptly, a thickness of the first top coat layer 112 is around 0.3 mm.

A second top coat layer of plastic/vinyl ester resin 114 with a relatively high chemical resistance is applied to the inner surface of the first top coat layer 112. The second top coat layer 114 is aptly pigmented blue to provide a clear visual indicator to the installer that the entire outer surface of the first top coat layer 112 has been covered, but it may be any suitable colour for this purpose. This layer is substantially fuel resistant, particularly to ethanol. Aptly, a thickness of the second top coat layer 114 is around 0.5 mm.

Double-sided adhesive tape is used to adhere adjacent layers together and along join lines in the same layer instead of using a curable liquid adhesive which helps speed up the installation process. The tape is used for assembly purposes only and each cylindrical layer is self-supporting. Aptly, the tape is configured to dissolve in the presence of petroleum fuel, such as in the event of a leak which introduces fuel into the interstitial space. The interstitial space can be opened up, such as at the bottom of the tank, and flushed in the knowledge no adhesive is in the space and no dead spots exist before the tank is repaired, the interstitial space re-evacuated, and the tank re-filled.

Certain embodiments of the present invention therefore provide a tank lining assembly that is compact to maximise the storage volume of the tank and which is non-complex and efficient to install. The tank lining assembly includes a monitorable interstitial space configured to eliminate lateral dead-spots as associated with some known lining systems and methods, whilst maximising fluid communication/flow therethrough for optimal leak monitoring and detection.

1. A fluid impervious composite lining for a storage vessel, comprising:
a base layer adherable to an inner surface of a storage vessel wall;
at least one fluid impervious layer; and
a woven mesh layer located between the base layer and the at least one fluid impervious layer, wherein the woven mesh layer comprises a metallic material and defines a plurality of open cells in fluid communication with each other to form a monitorable interstitial space within the lining.

2. The lining according to claim 1, wherein the woven mesh layer is located on an inner surface of the base layer.

3. (canceled)

4. The lining according to claim 1, wherein the metallic material is aluminum.

5. The lining according to claim 1, comprising a spacer layer having spaced apart protrusions extending towards the base layer and defining a plurality of passageways between the protrusions, wherein the protrusions of the spacer layer engage the woven mesh layer and the plurality of passageways and open cells are fluidly connected to laterally extend a monitorable volume of the interstitial space

6. The lining according to claim 5, wherein the spacer layer comprises a sheet panel region defining an outer surface from which the protrusions extend and an opposed substantially smooth inner surface.

7. (canceled)

8. The lining according to claim 6, wherein the spacer layer comprises a glass reinforced plastic material.

9. The lining according to claim 1, wherein the base layer comprises a substantially flexible material.

10. The lining according to claim 5, wherein the at least one fluid impervious layer comprises a first sealing layer applied to the inner surface of the spacer layer, wherein the first sealing layer comprises a first colour pigment.

11. The lining according to claim 10, wherein the at least one fluid impervious layer comprises a second sealing layer applied to the first sealing layer, wherein the second sealing layer comprises a second colour pigment different to the first colour.

12. The lining according to claim 11, wherein the at least one fluid impervious layer comprises a third sealing layer applied to the second sealing layer, wherein the third sealing layer comprises a third colour pigment different to the second colour.

13. (canceled)

14. The lining according to claim 1, wherein adjacent layers of the liner are adhered to each other by adhesive tape.

15. The lining according to claim 14, wherein the tape is configured to dissolve in petroleum fuel.

16. A storage vessel comprising a lining according to claim 1.

17. A method of lining a storage vessel with a fluid impervious composite lining, comprising:
applying a base layer to an inner surface of a storage vessel wall;
locating a woven mesh layer inboard of the base layer, wherein the mesh layer comprises a metallic material and defines a plurality of open cells in fluid communication with each other to form a monitorable interstitial space within the lining; and
applying at least one fluid impervious layer inboard of the mesh layer.

18. The method according to claim 17, comprising locating a spacer layer on the mesh layer, wherein the spacer layer comprises spaced apart protrusions extending towards and engaged with the mesh layer and defines a plurality of passageways between the protrusions fluidly connected with the open cells of the mesh layer to laterally extend a monitorable volume of the interstitial space.

19. (canceled)

20. The method according to claim 18 wherein applying at least one fluid impervious layer comprises applying a first sealing layer to a substantially smooth inner surface of the spacer layer, wherein the first sealing layer comprises a first colour pigment.

21. The method according to claim 20, wherein applying at least one fluid impervious layer comprises applying a second sealing layer to the first sealing layer, wherein the second sealing layer comprises a second colour pigment different to the first colour.

22. The method according to claim 21, wherein applying at least one fluid impervious layer comprises applying a third sealing layer to the second sealing layer, wherein the third sealing layer comprises a third colour pigment different to the second colour.

23. The method according to claim 17, comprising locating double-sided adhesive tape between adjacent ones of said layers.

24. (canceled)

25. The method according to claim 17, wherein the woven mesh layer comprises a metallic material, and optionally aluminum.
